(19) United States
(12) Patent Application Publication
(10) Pub. No.: US 2006/0240921 A1
(43) Pub. Date: Oct. 26, 2006

(54) Methods and apparatus for adjusting belt tension of a scrubber

(76) Inventors: Joseph Yudovsky, Campbell, CA (US); Tai T. Ngo, Dublin, CA (US); Anne-Douce MP. Coulin, Stanford, CA (US)

Correspondence Address: DUGAN & DUGAN, PC, 55 SOUTH BROADWAY, TARRYTOWN, NY, 10591, US

(21) Appl. No.: 11/201,402

(22) Filed: Aug. 10, 2005

Related U.S. Application Data
(60) Provisional application No. 60/600,284, filed on Aug. 10, 2004.

(51) Int. Cl. F16H 7/08; F16H 7/14

(52) U.S. Cl. 474/101; 474/115

(57) ABSTRACT

In a first aspect, a method is provided for adjusting tension of a belt of a semiconductor device manufacturing tool. The first method includes (1) coupling an elastic element between a pulley coupled to the belt and a fixed surface of the semiconductor device manufacturing tool; and (2) compressing or decompressing the elastic element so as to adjust at least one of a height and a tilt of the pulley and a tension of the belt coupled to the pulley. Numerous other aspects are provided.

The present application claims priority from U.S. Provisional Patent Application Ser. No. 60/600,284, filed Aug. 10, 2004, and titled “METHODS AND APPARATUS FOR ADJUSTING BELT TENSION OF A SCRUBBER” which is hereby incorporated by reference herein in its entirety.

### FIELD OF THE INVENTION

The present invention relates generally to semiconductor device manufacturing, and more particularly to methods and apparatus for adjusting belt tension of a semiconductor device manufacturing tool such as a scrubber.

### BACKGROUND

In a conventional scrubber, a belt and pulley system generally is employed to rotate the scrubber brushes of the scrubber. During use, belt length and/or pulley position may vary, and belt tension may need to be adjusted. In one conventional design, the pulleys that drive the scrubber brushes of a scrubber are coupled to a mounting block, and belt tensioning requires adjustment of mounting block position. However, adjusting mounting block position may place excessive stress on the screws, tapped holes or other fasteners of the mounting block, which may result in unwanted wear and/or particle formation.

Accordingly, methods and apparatus for adjusting belt tension of a scrubber are desired.

### SUMMARY OF THE INVENTION

In a first aspect of the invention, a method is provided for adjusting tension of a belt of a semiconductor device manufacturing tool. The first method includes (1) coupling an elastic element between a pulley coupled to the belt and a fixed surface of the semiconductor device manufacturing tool; and (2) compressing or decompressing the elastic element so as to adjust at least one of a height and a tilt of the pulley and a tension of the belt coupled to the pulley.

In a second aspect of the invention, a method is provided for adjusting tension of a belt of a scrubber. The method includes (1) coupling an elastic element between a pulley coupled to the belt and a fixed surface of the scrubber; and (2) compressing or decompressing the elastic element so as to adjust at least one of a height and a tilt of the pulley and a tension of the belt coupled to the pulley.

In a third aspect of the invention, a scrubber is provided that includes (1) a lid; (2) an elastic element coupled to the lid; (3) a pulley coupled to the elastic element and adapted to couple to a belt; and (4) at least one adjustment device coupled to the lid and adapted to compress or decompress the elastic element so as to adjust at least one of a height and a tilt of the pulley and a tension of any belt coupled to the pulley.

In a fourth aspect of the invention, an apparatus is provided for adjusting belt tension of a semiconductor device manufacturing tool. The apparatus includes (1) a mounting block; (2) a pulley coupled to the mounting block and adapted to couple to a motor via a belt; (3) a mounting plate; (4) an elastic element coupled between the mounting plate and the mounting block; (5) a plurality of adjustment devices that couple the elastic element between the mounting plate and the mounting block; and (6) a plurality of nuts coupled to the mounting block and the plurality of adjustment devices. Rotation of each adjustment device causes (a) compression or decompression of the elastic element; and (b) adjustment at least one of a height and tilt of the mounting block and the pulley coupled to the mounting block so as to adjust a tension of any belt coupled to the pulley. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a side view of an apparatus for adjusting belt tension of a semiconductor device manufacturing tool in accordance with an embodiment of the present invention.

FIG. 2 is a front view of the apparatus for adjusting belt tension of a semiconductor device manufacturing tool in accordance with an embodiment of the present invention.

FIG. 3 is a cross-sectional front view of the apparatus for adjusting belt tension of a semiconductor device manufacturing tool in accordance with an embodiment of the present invention.

FIG. 4 is an isometric view of the apparatus for adjusting belt tension of a semiconductor device manufacturing tool in accordance with an embodiment of the present invention.

FIG. 5 is a side view of a shim in accordance with an embodiment of the present invention.

### DETAILED DESCRIPTION

The present invention provides methods and apparatus for adjusting belt tension (of a semiconductor device manufacturing tool such as a scrubber). More specifically, the present invention provides methods and apparatus for adjusting a position of a mounting block to which a belt is operatively coupled, without placing excessive stress on components of the semiconductor device manufacturing tool. Unwanted particle formation thereby may be reduced.

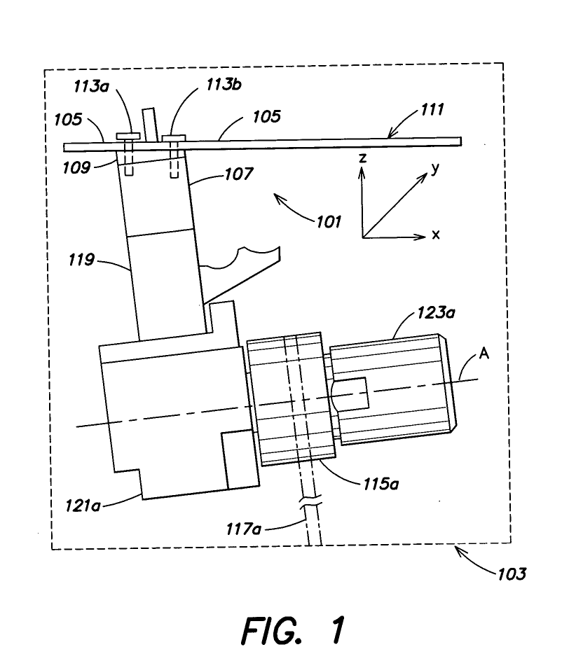

FIG. 1 is a side view of an apparatus 101 for adjusting belt tension of a semiconductor device manufacturing tool 103 (shown in phantom) in accordance with an embodiment of the present invention. With reference to FIG. 1, the apparatus 101 includes a mounting plate 105 coupled to a mounting block 107 via an elastic element (or member) 109. The mounting plate 105 may be, for example, a portion of a lid 111 of a tank (e.g., a brush box) included in the semiconductor device manufacturing tool 103. In one embodiment, the mounting plate 105 is about two inches wide, one inch long and less than or equal to about ¼ inch thick (although, the mounting plate 105 may be dimensioned differently). The mounting plate 105 may be formed from stainless steel. Alternatively, the mounting plate 105 may be formed from one or more additional materials or different materials. Similarly, the mounting block 107 may be about 50 mm wide, 25 mm long and 24 mm thick (although, the mounting block 107 may be dimensioned differently). The mounting block 107 may be formed from plastic, such as a thermoplastic polyester (e.g., Ertalyte® available from Quadrant Engineering Plastic Products). Alternatively, the mounting block 107 may be formed from one or more additional materials or different materials.

Further, the elastic element 109 may be about 1½ inches long, one inch wide and ½ inch thick (although, the elastic element 109 may be dimensioned differently). The elastic element 109 may be formed from a fluoroelastomer (e.g., Viton® available from Dupont) or EPDM. Alternatively, the elastic element 109 may be formed from one or more additional materials or different materials. The elastic element 109 is adapted to compress (e.g., between the mounting plate 105 and the mounting block 107) as described further below.

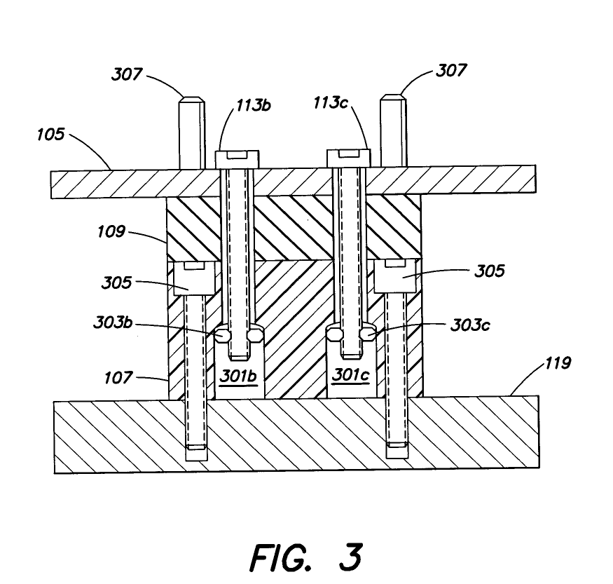

The apparatus 101 includes a plurality of adjustment mechanisms (e.g., screws 113) adapted to couple the elastic element 109 between the mounting plate 105 and the mounting block 107 (e.g., in cooperation with a plurality of nuts (not shown in FIG. 1; 303 in FIG. 3)). Adjustment mechanisms other than the screws 113 and/or nuts 303 may be employed (e.g., bolts, etc.). In one embodiment, the plurality of adjustment screws 113 may be 4 mm screws and formed from stainless steel or titanium (although, another size and/or material may be used). The apparatus 101 includes four adjustment screws 113a-d (only two shown in FIG. 1), and therefore, four nuts 303a-d. However, a larger or smaller number of adjustment screws 113 and corresponding nuts 303 may be employed.

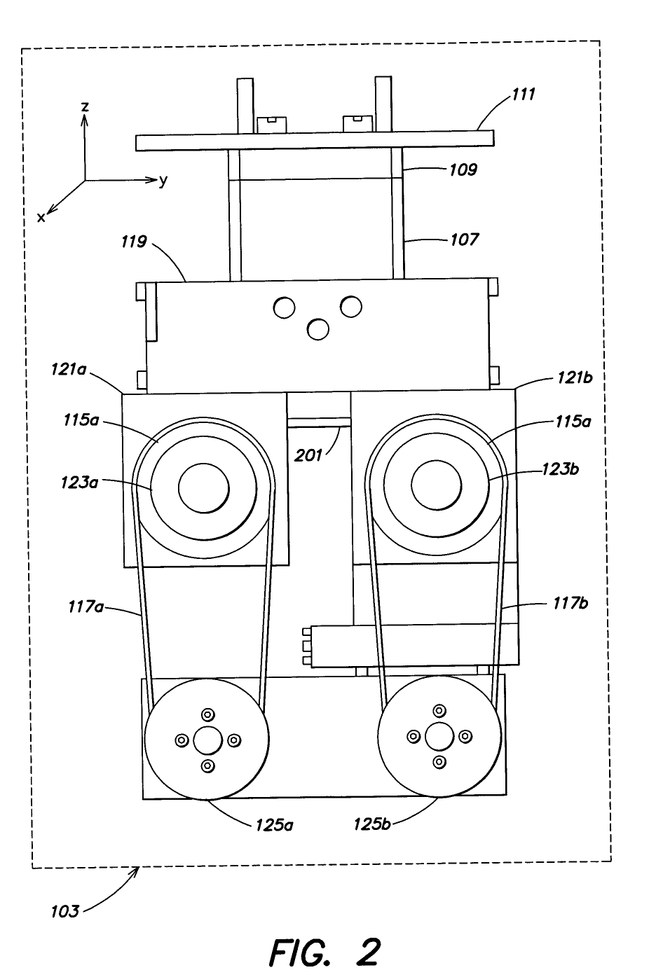

A pulley 115a adapted to receive a belt 117a (shown in phantom) is coupled to the apparatus 101. For example, a block (or gripper) 119 including a pneumatic actuator, may couple to the mounting block 107 (e.g., a bottom surface of the mounting block 107) of the apparatus 101. The pulley 115a is coupled to a corresponding pulley housing 121a, which is movably coupled to the block 119. The semiconductor device manufacturing tool 103 may include two pulleys 115a-b (only one pulley 115a shown in FIG. 1) that are coupled to the apparatus 101 via corresponding pulley housings 121a-b (FIG. 2). Each pulley 115a-b is further adapted to couple to a corresponding brush coupling 123a-b to which a scrubber brush (e.g., employed during semiconductor device manufacturing) (not shown) may couple. Another configuration may be employed to couple the pulleys 115a-b to the apparatus 101. The block/gripper 119 may be employed to move the brush couplings 123a-b (and any brushes attached thereto) together for scrubbing of a substrate or apart during loading of a substrate into or out of the semiconductor device manufacturing tool 103.

FIG. 2 is a front view of the apparatus 101 of FIG. 1 in accordance with an embodiment of the present invention. With reference to FIG. 2, the block 119 coupled to the apparatus 101 includes a rail 201 to which the pulley housings 121a-b are movably coupled. More specifically, the pulley housings 121a-b may employ the rail 201 to slide along a y-axis, thereby moving brushes (not shown) coupled to the pulley housings 121a-b (via brush couplings 123a-b) toward or away from each other.

Belts 117a-b coupled to respective pulleys 115a-b are also coupled to corresponding lower pulleys 125a-b, which in the embodiment shown have a fixed position (e.g., inside the tank of the semiconductor device manufacturing tool 103). For example, the lower pulleys 125a-b may be part of a gear reducer, which translates motion outside of the tank into motion of the two lower pulleys 125a-b. Consequently, rotation of the lower pulleys 125a-b causes the pulleys 115a-b coupled to the pulley housings 121a-b and brushes connected thereto to rotate.

When the belts 117a-b are installed on the pulleys 115a-b coupled to the pulley housings 121a-b, a load (e.g., tension) is applied to the pulleys 115a-b and the belts 117a-b. As described below, the present invention provides methods and apparatus for adjusting such tension.

FIG. 3 is a cross-sectional front view of the apparatus 101 for adjusting belt tension of the semiconductor device manufacturing tool 103 in accordance with an embodiment of the present invention. With reference to FIG. 3, each of the mounting plate 105, elastic element 109 and mounting block 107 is adapted to receive the plurality of adjustment screws 113a-d. More specifically, the mounting plate 105, elastic element 109 and mounting block 107 include holes for receiving the plurality of adjustment screws 113a-d. Further, the mounting block 107 includes a housing 301a-d (only 301b and 301c shown in FIG. 3) for each nut 303a-d (only 303b and 303c shown in FIG. 3). Each housing 301a-d is sized and shaped so as to prevent its respective nut 303a-d from rotating when the adjustment screw 113a-d (only 113b and 113c shown in FIG. 3) corresponding to the nut 303a-d is rotated. In one embodiment, one or more (e.g., all) of the nuts 303a-d are polygonal, for example, and the corresponding nut housings 301a-d are shaped accordingly. Alternatively, the nuts 303a-d and corresponding nut housings 301a-d may be shaped differently. For example, in one or more embodiments, the nuts 303a-d may be spherical or the like (e.g., a shape with a similar range of motion), and the nut housings 301a-d, which are adapted to receive the spherical nuts 303a-d, are shaped accordingly. In either case, each nut 303a-d is adapted so as not to rotate when a corresponding adjustment screw 113a-d is turned (e.g., loosened or tightened slightly). More specifically, a nut 303a-d does not follow its corresponding adjustment screw 113a-d when the adjustment screw 113a-d is turned.

Additionally, as described below, each nut 303a-d may tilt (e.g., tilt slightly) when an adjustment screw 113a-d corresponding to the nut 303a-d tilts. More specifically, in the former embodiment, when a screw corresponding to a polygonal nut 303a-d tilts, the polygonal nut 303a-d coupled to the screw also tilts or pivots (which deforms the nut housing 301a-d of the mounting block 107). Similarly, in the latter embodiment, when a screw corresponding to a spherical nut 303a-d tilts, the spherical nut 303a-d coupled to the screw also tilts or pivots. Pivoting of a spherical nut, however, does not generally deform the nut housing. In one embodiment, each nut 303a-d has an angular range of movement or degree of freedom of about 2-3 degrees (although in other embodiments each nut 303a-d may have a larger or smaller angular range of movement or degree of freedom).

As shown in FIG. 3, the mounting block 107 may be adapted to receive a plurality of screws 305 that couple the mounting block 107 to the block 119 (which may include an actuator for moving the brush couplings 123a-b together or apart as previously described). For example, the mounting block 107 may include a plurality of holes for receiving the block screws 305; and the block 119 may include tapped holes adapted to receive the block screws 305. Further, the mounting plate 105 may be adapted to receive one or more removable installation pins 307, which may be used to provide alignment during pre-installation.

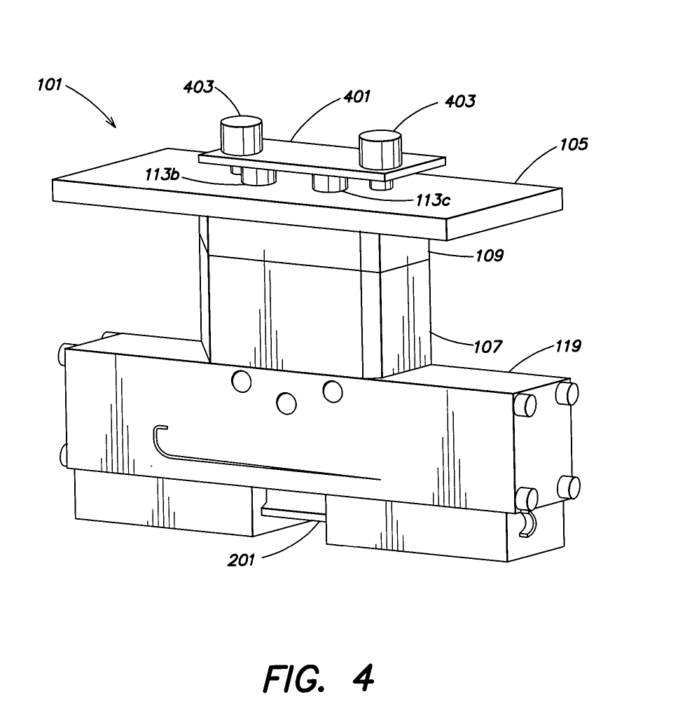

FIG. 4 is a schematic representation of an isometric view of the apparatus 101 in accordance with an embodiment of the present invention. With reference to FIG. 4, the apparatus 101 for adjusting belt tension of a semiconductor device manufacturing tool 103 may include a locking plate 401 adapted to couple to the mounting plate 105 (e.g., a top surface of the mounting plate 105) via a plurality of locking screws 403 or other fasteners. For example, the locking plate 401 may include a plurality holes and the mounting plate 105 may include a plurality tapped holes for receiving corresponding locking screws 403. When installed, the locking plate 401 (e.g., a bottom surface of the locking plate 401) is coupled (e.g., secured) to heads of the adjustment screws 113a-d. The locking plate 401 may push heads of the locking screws 113a-d into the mounting plate 105. In this manner, once the plurality of adjustment screws 113a-d are adjusted, the locking plate 401 may be employed to prevent movement (e.g., rotation) of the adjustment screws 113a-d, for example, due to vibration during semiconductor device manufacturing.

In one embodiment, the locking plate 401 is about 50 mm long, about 30 mm wide and about 8 mm thick (although, the locking plate 401 may be dimensioned differently). The locking plate 401 may be formed from stainless steel or any other suitable material. The locking screws 403 may be made of stainless steel, titanium or any other suitable material.

The operation of the apparatus 101 is now described with reference to FIGS. 1-4. In operation, at least one of the plurality of adjustment screws 113a-d may be adjusted (e.g., tightened or loosened by turning), for example, by a user. In response to such adjustment, the elastic element 109 may compress or decompress. For example, if one of the adjustment screws 113a-d is tightened, a portion of the elastic element 109 surrounding the adjustment screw 113a-d compresses.

Compression or decompression of the elastic element 109 (e.g., a portion of the elastic element 109 surrounding an adjusted adjustment screw 113a-d) may cause the longitudinal axis of the adjustment screw 113a-d to change (e.g., tilt). Consequently, the adjustment screws 113a-d have some freedom of angular movement relative to the mounting block 107 during adjustment. (Accordingly, the respective longitudinal axes of two or more of the plurality of adjustment screws 113a-d may not be parallel.)

Because a portion of the elastic element 109 surrounding any adjusted adjustment screw 113a-d compresses or decompresses, the height (e.g., relative to a tank bottom) or tilt of the mounting block 107 may be adjusted. Adjusting all screws 113a-d equally raises or lowers the mounting block without tilting the same. In this manner, the mounting block 107 may move along a z-axis (e.g., vertically).

Adjusting fewer than all of the adjustment screws 113a-d or adjusting all adjustment screws 113a-d unequally may compress or decompress the elastic element 109 unevenly and cause the mounting block 107 to tilt relative to an xy-plane and/or a yz-plane (FIG. 1). Additionally or alternatively, adjusting the adjustment screws 113a-d may cause the mounting block to tilt relative to an xz-plane. In one embodiment, the mounting block 107 may move about 0.1 to 0.2 inches relative to the xy-plane and/or yz-plane. In other embodiments, the mounting block 107 may move a larger or smaller distance relative the xy-plane and/or the yz-plane.

Components coupled to the mounting block 107, such as the pulley housings 121a-b, pulleys 115a-b, brush couplings 123a-b and/or brushes coupled thereto, may be adjusted in a similar manner. By adjusting the height and/or tilt of a pulley 115a-b coupled to the mounting block 107, a tension of a corresponding belt 117a-b coupled thereto may be adjusted. In this manner, the apparatus 101 may accommodate a belt 117a-b which is too tight or too loose, and/or may accommodate for a difference in lengths of belts 117a-b coupled to the apparatus 101. Further, belt slippage and/or misalignment (e.g., when a belt climbs on a pulley flange), for example, may be prevented without placing excessive stress on the screws 113a-d and/or nuts 303a-d (or other components) of the apparatus 101. Through adjustment of the mounting block, an axis A of a pulley 115a-b may be at an incline from a horizontal axis (e.g., x-axis) when the pulley is unloaded (e.g., not coupled to a belt 117a-b) as shown in FIG. 1 and, may be horizontal or approximately horizontal when the pulley 115a-b is under load (e.g., when a belt 117a-b is coupled to the pulley 115a-b and/or when a brush is coupled to a brush coupling 123a-b).

As described above, after adjustment of the adjustment screws 113a-d, a locking plate 401 may be coupled to the heads of the adjustment screws 113a-d. In this manner, the locking plate 401 prevents movement of the adjustment screws 113a-d (e.g., further adjustment of the adjustment screws 113a-d or movement of the adjustment screws 113a-d due to vibration during semiconductor device manufacturing).

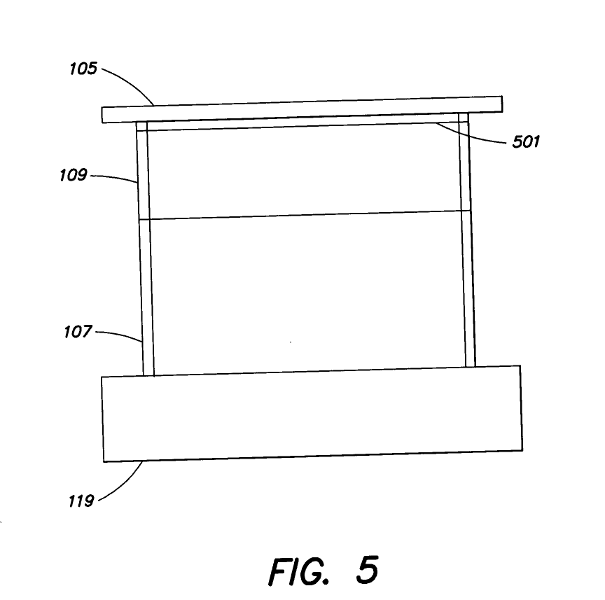

FIG. 5 is a schematic representation of a side view of a shim 501 in accordance with an embodiment of the present invention. With reference the FIG. 5, the shim 501 may be coupled to (e.g., between) the mounting plate 105 and elastic element 109. The shim 501 may be formed from plastic, such as a thermoplastic polyester (e.g., Ertalyte® available from Quadrant Engineering Plastic Products). Alternatively, the shim 501 may be formed from additional materials or different materials. The shim 501 is dimensioned to compensate for a misalignment greater than the tolerance of the apparatus 101 (e.g., a gross vertical misalignment). For example, if a gap is created between the mounting plate 105 and elastic element 109 when a belt 117a-b is coupled to a pulley 115 a-b (because the elastic element 109 is too thin), the shim 501 may be employed to ensure that the elastic element 109 is coupled to the mounting plate 105, thereby allowing the elastic element 109 to compress, and adjustment of at least one of a height and a tilt of the mounting block 107.

The foregoing description discloses only exemplary embodiments of the invention. Modifications of the above disclosed apparatus and methods which fall within the scope of the invention will be readily apparent to those of ordinary skill in the art. For instance, in embodiments described above, the elastic element 109 may have a specific height, width and thickness. Alternatively, the elastic element 109 may be formed from a plurality of springs corresponding to and coupled to (e.g., surrounding) the plurality of adjustment screws 113a-d or other adjustment mechanisms. In such embodiments, the plurality of springs provide similar adjustability.

Accordingly, while the present invention has been disclosed in connection with exemplary embodiments thereof, it should be understood that other embodiments may fall within the spirit and scope of the invention, as defined by the following claims.

The invention claimed is:

1. A method of adjusting tension of a belt of a semiconductor device manufacturing tool, comprising:
coupling an elastic element between a pulley coupled to the belt and a fixed surface of the semiconductor device manufacturing tool; and
compressing or decompressing the elastic element so as to adjust at least one of a height and a tilt of the pulley and a tension of the belt coupled to the pulley.

2. The method of claim 1 wherein coupling an elastic element between a pulley coupled to the belt and a fixed surface of the semiconductor device manufacturing tool includes coupling the elastic element between a lid of a scrubber box and a pulley housing to which the pulley is coupled.

3. The method of claim 2 wherein coupling the elastic element between a lid of a scrubber box and a pulley housing to which the pulley is coupled includes coupling the elastic element between the lid of the scrubber box and a mounting block coupled to the pulley housing.

4. The method of claim 3 wherein compressing or decompressing the elastic element includes rotating at least one of a plurality of adjustment devices.

5. The method of claim 4 wherein rotating at least one of a plurality of adjustment devices includes adjusting a long axis of at least one adjustment screw.

6. The method of claim 4 further comprising locking further rotation of the adjustment devices.

7. A method of adjusting tension of a belt of a scrubber, comprising:
coupling an elastic element between a pulley coupled to the belt and a fixed surface of the scrubber; and
compressing or decompressing the elastic element so as to adjust at least one of a height and a tilt of the pulley and a tension of the belt coupled to the pulley.

8. The method of claim 7 wherein coupling an elastic element between a pulley coupled to the belt and a fixed surface of the scrubber includes coupling the elastic element between a lid of the scrubber and a pulley housing to which the pulley is coupled.

9. The method of claim 8 wherein coupling the elastic element between a lid of the scrubber and a pulley housing to which the pulley is coupled includes coupling the elastic element between the lid of the scrubber and a mounting block coupled to the pulley housing.

10. The method of claim 9 wherein compressing or decompressing the elastic element includes rotating at least one of a plurality of adjustment devices.

11. The method of claim 10 wherein rotating at least one of a plurality of adjustment devices includes adjusting a long axis of at least one adjustment screw.

12. The method of claim 10 further comprising locking further rotation of the adjustment devices.

13. The method of claim 7 wherein coupling an elastic element between a pulley coupled to the belt and a fixed surface of the scrubber includes coupling an elastic element between a lid of the scrubber and a mounting block via a plurality of adjustment screws and a corresponding plurality of nuts coupled to the mounting block.

14. The method of claim 13 wherein compressing or decompressing the elastic element includes:
adjusting at least a first adjustment screw of the plurality of adjustment screws so as to:
compress or decompress the elastic element;
adjust a longitudinal axis of the first adjustment screw;
pivot a nut corresponding to the first adjustment screw; and
adjust at least one of a height and tilt of the mounting block.

15. A scrubber comprising:
a lid;
an elastic element coupled to the lid;
a pulley coupled to the elastic element and adapted to couple to a belt; and
at least one adjustment device coupled to the lid and adapted to compress or decompress the elastic element so as to adjust at least one of a height and a tilt of the pulley and a tension of any belt coupled to the pulley.

16. The scrubber of claim 15 wherein the elastic element comprises a fluoroelastomer.

17. The scrubber of claim 15 further comprising a mounting block coupled between the elastic element and the pulley.

18. The scrubber of claim 17 further comprising at least one adjustment device coupled through the lid and elastic element to the mounting block.

19. The scrubber of claim 18 wherein each adjustment device is coupled to a nut within the mounting block.

20. The scrubber of claim 18 wherein each adjustment device is adapted to rotate so as to compress or decompress the elastic element.

21. The scrubber of claim 15 further comprising:
a motor;
a belt coupled between the motor and pulley so that the pulley rotates with the motor; and
a scrubber brush coupled to the pulley and adapted to rotate with the pulley.

22. An apparatus for adjusting belt tension of a semiconductor device manufacturing tool, comprising:
a mounting block;
a pulley coupled to the mounting block and adapted to couple to a motor via a belt;
a mounting plate;
an elastic element coupled between the mounting plate and the mounting block;
a plurality of adjustment devices that couple the elastic element between the mounting plate and the mounting block; and
a plurality of nuts coupled to the mounting block and the plurality of adjustment devices;
wherein rotation of each adjustment device causes:
compression or decompression of the elastic element; and
adjustment at least one of a height and tilt of the mounting block and the pulley coupled to the mounting block so as to adjust a tension of any belt coupled to the pulley.

23. The apparatus of claim 22 further comprising:
a motor;
a belt coupled between the motor and pulley so that the pulley rotates with the motor; and
a scrubber brush coupled to the pulley and adapted to rotate with the pulley.
